(19) United States
(12) Patent Application Publication
(10) Pub. No.: US 2025/0269627 A1
(43) Pub. Date: Aug. 28, 2025

(54) LAMINATE

(71) Applicant: ROGERS CORPORATION, Chandler, AZ (US)

(72) Inventors: Bruce B. FITTS, Fountain Hills, AZ (US); Yayi YE, Suzhou (CN); Thomas A. KOES, Riverside, CA (US)

(21) Appl. No.: 19/064,275

(22) Filed: Feb. 26, 2025

Related U.S. Application Data
(60) Provisional application No. 63/558,158, filed on Feb. 27, 2024.

(51) Int. Cl. B32B 15/08; B32B 5/02; B32B 7/12; B32B 15/20; B32B 37/04; H01F 5/06; H01F 37/00

(52) U.S. Cl. CPC B32B 15/08; B32B 5/022; B32B 5/024; B32B 7/12; B32B 15/20; B32B 37/04; H01F 5/06; H01F 37/00; B32B 2250/05; B32B 2250/40; B32B 2260/025; B32B 2260/046; B32B 2264/107; B32B 2305/30; B32B 2305/55; B32B 2307/204; B32B 2307/206; B32B 2307/302; B32B 2307/7376; B32B 2367/00; B32B 2379/08; B32B 2386/00

(57) ABSTRACT

A laminate includes a first outer copper layer; a second outer copper layer; a multilayer construct having at least three polymer films disposed between the first and second outer copper layers. Adjacent ones of the at least three polymer layers have dissimilar dielectric constant, Dk, values, dissimilar thicknesses, or preferably both dissimilar Dk values and dissimilar thicknesses. Adjacent ones of the first and second outer copper layers, and the at least three polymer layers, are bonded to each other. Each polymer film of the at least three polymer films has a voltage breakdown strength equal to or greater than 200 kV/mm, or equal to or greater than 5 kV at a film thickness of 25 micrometers.

### CROSS REFERENCE TO RELATED APPLICATION

This application claims the benefit of U.S. Provisional Application No. 63/558,158, filed on Feb. 27, 2024, the content of which is incorporated by reference in its entirety herein.

### BACKGROUND

The present disclosure relates generally to a laminate, and particularly to a bonded laminate with outer copper layers.

As the electric vehicle market evolves, it is anticipated that demand will increase for wireless options of energy transfer to charge batteries. Inductive transmitter coils for use in such energy transfer systems must operate at high power levels, such as 150 kW, to complete the charging process in a reasonable length of time. As such, there is a need in the field of electric vehicles, and other applications, for materials suitable for inductive transmitter coil operation at such demanding high power levels.

The following publications may be considered as useful background art: US20050013998A1; US20100172066A1; US20140160623A1; and, US20190326034A1.

While existing laminates may be useful for their intended purpose, the art relating to laminates would be advanced by a construct as disclosed herein.

### BRIEF SUMMARY

An embodiment includes a laminate as defined by the appended independent claim(s). Further advantageous modifications of the laminate are defined by the appended dependent claims.

In an embodiment, a laminate comprises: a first outer copper layer; a second outer copper layer; a multilayer construct comprising at least three polymer films disposed between the first and second outer copper layers; wherein adjacent ones of the at least three polymer layers have dissimilar dielectric constant, Dk, values, dissimilar thicknesses, or preferably both dissimilar Dk values and dissimilar thicknesses; wherein adjacent ones of the first and second outer copper layers, and the at least three polymer layers, are bonded to each other; wherein each polymer film of the at least three polymer films has a voltage breakdown strength equal to or greater than 200 kV/mm, or equal to or greater than 5 kV at a film thickness of 25 micrometers.

In an embodiment, a capacitively coupled inductive coil comprises: one or more of the above noted laminate; wherein the respective first and second outer copper layers are structured and configured to form the capacitively coupled inductive coil.

The above features and advantages and other features and advantages of the invention are readily apparent from the following detailed description of the invention when taken in connection with the accompanying drawings.

### BRIEF DESCRIPTION OF THE DRAWINGS

Referring to the exemplary non-limiting drawings wherein like elements are numbered alike in the accompanying Figures:

FIG. 1 depicts a rotated isometric view of a laminate having three polymer film layers sandwiched between two outer copper layers, in accordance with an embodiment;

FIGS. 2A, 2B, 2C, 2D, 2E, 2F, 2G, 2H, 2I, 2J, 2K, 2L, and 2M, depict side views of various schematic diagrams of multilayer constructions of polymer film layers each having a defined mil thickness, in accordance with an embodiment;

FIGS. 3, 4 and 5, depict various short-time breakdown voltage measurements as a function of material thickness of various polymer film layers for use in a construct similar to that of FIG. 1, in accordance with an embodiment;

FIG. 6 depicts a schematic representation of a capacitively coupled inductive coil, in accordance with an embodiment; and

FIG. 7 depicts patterned conductors suitable for use with a laminate as disclosed herein, and suitable for use in a capacitively coupled inductive coil as disclosed herein, in accordance with an embodiment.

One skilled in the art will understand that the drawings, further described herein below, are for illustration purposes only. It will be appreciated that for simplicity and clarity of illustration, elements shown in the figures have not necessarily been drawn to scale. For example, the dimensions or scale of some of the elements may be exaggerated relative to other elements for clarity. Further, where considered appropriate, reference numerals may be repeated among the figures to indicate corresponding or analogous elements, or analogous elements may not be repetitively enumerated in all figures where it will be appreciated and understood that such enumeration where absent is inherently disclosed.

### DETAILED DESCRIPTION

As used herein, the phrase “embodiment” means “embodiment disclosed and/or illustrated herein”, which may not necessarily encompass a specific embodiment of an invention in accordance with the appended claims, but nonetheless is provided herein as being useful for a complete understanding of an invention in accordance with the appended claims.

Although the following detailed description contains many specifics for the purposes of illustration, anyone of ordinary skill in the art will appreciate that many variations and alterations to the following details are within the scope of the appended claims. For example, where described features may not be mutually exclusive of and with respect to other described features, such combinations of non-mutually exclusive features are considered to be inherently disclosed herein. Additionally, common features may be commonly illustrated in the various figures but may not be specifically enumerated in all figures for simplicity, but would be recognized by one skilled in the art as being an explicitly disclosed feature even though it may not be enumerated in a particular figure. Accordingly, the following example embodiments are set forth without any loss of generality to, and without imposing limitations upon, the claimed invention disclosed herein.

An embodiment, as shown and described by the various figures and accompanying text, provides a multi-layer dielectric laminate with at least three polymer film layers and with outer conductive layers, all bonded together such that each layer is in direct intimate contact with a corresponding adjacent layer, each polymer layer having dissimilar dielectric constant, Dk, values, or dissimilar thicknesses, relative to each other.

As used herein the term “direct intimate contact” means contact with no intervening substance or element therebetween, such as when a first polymer layer is bonded or fused to an adjacent polymer layer.

A dielectric substrate as disclosed herein is suited for the high voltages and electrical amperage associated with the desired power levels required for wireless charging of high power systems, 150 kW for example. A dielectric substrate as disclosed herein provides a means of increasing dielectric breakdown strength with enhanced reliability using rationally designed multilayer stack-ups of polymer films possessing different dielectric constants and/or thicknesses. In an embodiment, the multilayer dielectric substrates enable the manufacture of copper clad laminates suitable for the manufacture of high-power inductive transmitter coils.

Copper clad laminates are useful for the fabrication of inductive transmitter coils that can operate at high power levels. The laminate cores comprise a plurality of thin, low-loss, polymer films that possess different relative permittivity's. In an embodiment, by systematically varying the relative positions and thicknesses of the polymer films, as well as the layer count, high electrical breakdown strength is attained through a favorable distribution of electrical stress.

Homogeneous dielectric polymer films are commonly used for high-voltage electrical insulation. Metal-clad dielectric substrates used in the manufacture of printed circuit boards have traditionally been heterogeneous in composition, except for the use of adhesives to bond metal cladding to the substrates. Paradoxically, the dielectric strength (AC, DC) of heterogenous dielectric substrates typically reduces as thickness increases. Breakdown is often induced by inhomogeneities within the dielectric, such as porosity (air voids), chemical impurities, foreign-object-debris (FOD), polymer gels and other defects which are more likely to be present in thicker substrates resulting in partial electrical discharges that can lead to overall electrical, thermal, and electro-mechanical failures.

An embodiment as disclosed herein includes a plurality of varying and relatively thin layers of non-polar polymer films exhibiting high dielectric breakdown voltage strength and a variety of relative permittivity's which are either adhesively or fusion bonded to produce multi-layered composites. In an embodiment, the varying of the polymer films can be with respect to the thickness of the film, the dielectric constant (Dk) value of the film, or both thickness and Dk value. When a voltage is applied across the thickness of such a composite substrate, each polymer layer acts like a parallel-plate capacitor. With layers of capacitance effectively connected in series, the charge shift across each layer is the same, and consequently the voltage (AC or DC) is shared in proportion to the individual capacitance (C) values. The thickness (T) and relative permittivity (F) of each layer determines its capacitance. Since Kirchhoff's law is applicable, the sum of the individual voltage drops must be equal to the supply voltage. In an embodiment, the plurality of layers of polymer films are arranged in a symmetrical stack-up relative to a central plane that passes horizontally (parallel to the layers of the polymer films) through the stack-up, such that the layers on one side of the central plane are a mirror image of the layers on the opposite side of the central plane.

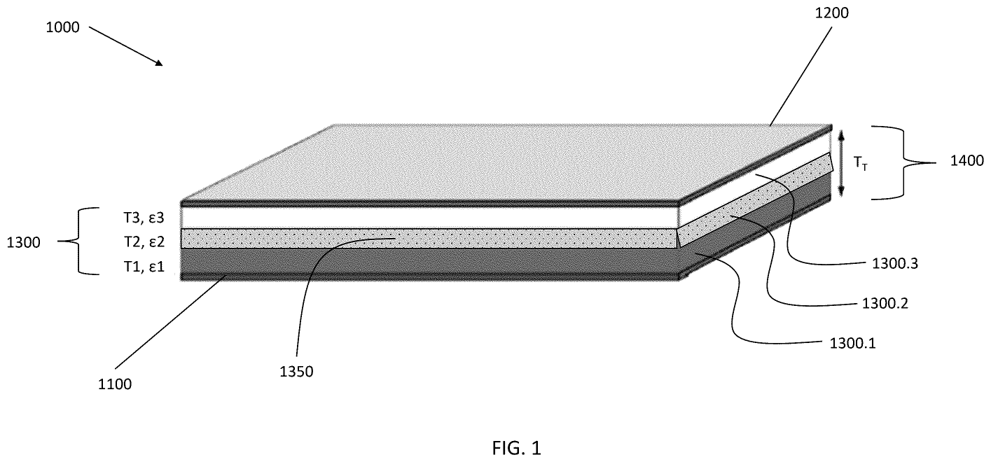

The FIG. 1 depicts a side view of an example laminate 1000 having a first outer copper layer 1100; a second outer copper layer 1200; at least three polymer films 1300 disposed between the first 1100 and the second 1200 outer copper layers; wherein adjacent ones 1300.1, 1300.2, 1300.3, of the at least three polymer layers 1300 have dissimilar dielectric constant, Dk, values, dissimilar thicknesses, or preferably both dissimilar Dk values and dissimilar thicknesses; wherein adjacent ones of the first 1100 and the second 1200 outer copper layers, and the at least three polymer layers 1300, are bonded to each other; and, wherein each polymer film 1300.1, 1300.2, 1300.3 of the at least three polymer films 1300 has a voltage breakdown strength equal to or greater than 200 kV/mm, or equal to or greater than 5 kV at a film thickness (T₁, T₂, T₃) equal to 25 micrometers. While only three polymer films 1300.1, 1300.2, 1300.3, are depicted in the FIG., it will be appreciated that a scope of the invention encompassed by the appended claims is not so limited and encompasses any number of polymer films supported by the disclosure herein and being suitable for an intended purpose disclosed herein.

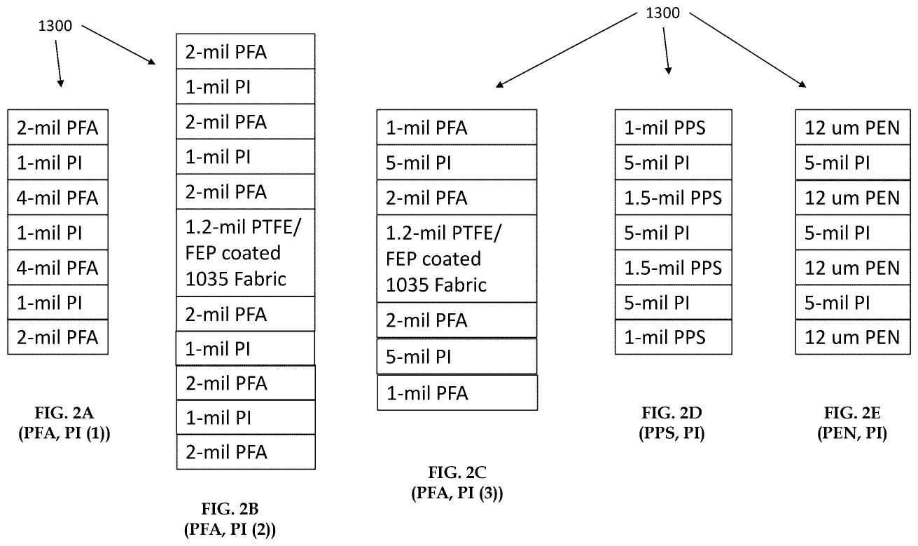

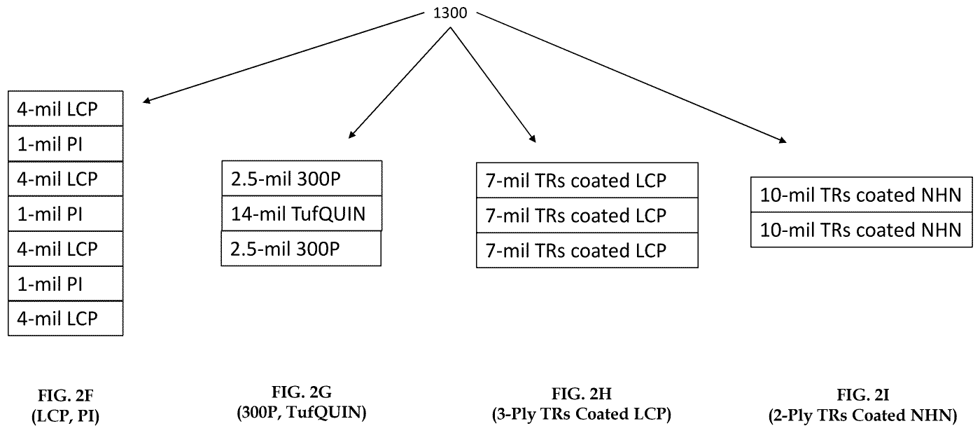

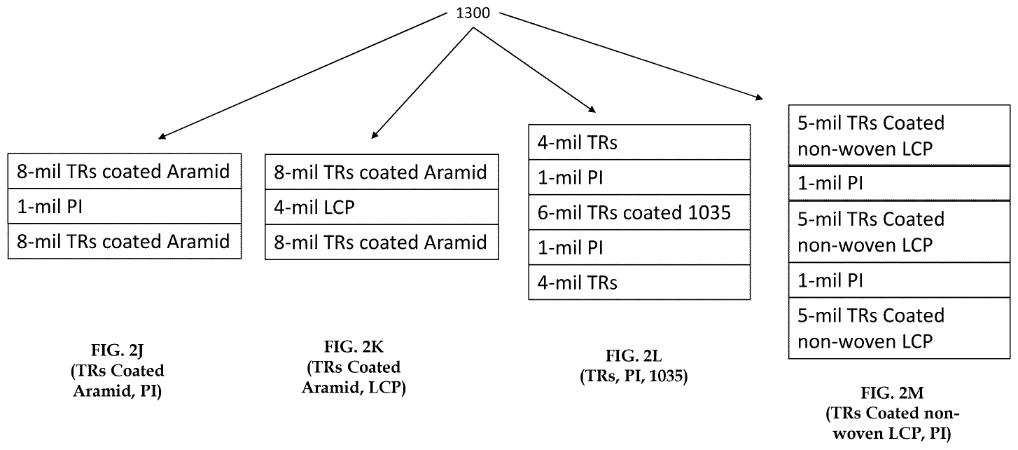

For example, FIGS. 2A-2M depict a variety of a plurality of polymer films stacked and bonded one on top of another (absent the above noted copper layers 1100, 1200), which will be discussed further herein below.

As used herein, the term dielectric constant, Dk, is used interchangeably with the term relative permittivity, F.

With reference to FIG. 1, and for capacitors arranged in series with each other, the charge is the same on each capacitor, such that:

Q_{T}=Q₁=Q₂=Q₃ Equation (1)
Where:
Q_{T}=is the total charge across the at least three polymer films 1300;
Q₁=is the charge across a first polymer film 1300.1 of the at least three polymer films 1300;
Q₂=is the charge across a second polymer film 1300.2 of the at least three polymer films 1300; and
Q₃=is the charge across a third polymer film 1300.3 of the at least three polymer films 1300.

Applying Kirchoff's voltage law around the closed loop gives:

$${V}_{T} = {V}_{1} + {V}_{2} + {V}_{3} \qquad Equation ( 2 )$$

According to Equation (2), distributing an impressed voltage across multiple layers of films can increase the breakdown voltage of the multi-layered material. The dielectric strength of a particular film decreases as the thickness increases, so if the voltage can be spread across multiple layers of films, the multilayer structure will have a higher breakdown voltage even if the total thickness is the same.

At the same time, the multilayer composites can optimally regulate the distributed voltage of each film layer. Since the capacitance C is given by:

$$C = \frac{A \times {ε}_{0} \times {ε}_{γ}}{T} \qquad Equation ( 3 )$$

Where:
A=area of multi-layer capacitive dielectric material;
εₒ=permittivity of multi-layer capacitive dielectric material in a vacuum;
ε_{y}=relative permittivity of multi-layer capacitive dielectric material, and
T=thickness of multi-layer capacitive dielectric material.

By adjusting the dielectric films with different dielectric constants, or using dielectric films with different thicknesses, it is possible to have different capacitances C for each layer.

### Given:

$$V = \frac{Q}{C} \qquad Equation ( 4 )$$

Where:
V=voltage across the capacitor construct;
Q=the charge on each layer of film of the multi-layer dielectric material of the capacitor construct; and
C=the capacitance of the capacitor construct.

According to the Equation (3), C is directly proportional to E and inversely proportional to T.

According to Equations (3) and (4), since each layer of dielectric film of the capacitor construct has the same value of Q, the capacitance C can be adjusted by varying the thickness of the film and/or the ε_{γ} of the film. Films with higher dielectric strengths can be designed to take on higher voltages V.

In an embodiment, each polymer film 1300.1, 1300.2, 1300.3, of the at least three polymer films 1300 has a volume electrical resistivity larger than 1×10¹⁵ Ω-m.

In an embodiment, each polymer film 1300.1, 1300.2, 1300.3, of the at least three polymer films 1300 has a similar dielectric constant, Dk, less than 10, at 1 kHz, 23° C. (73° F.).

In an embodiment, each polymer film 1300.1, 1300.2, 1300.3, of the at least three polymer films 1300 has a similar dissipation factor, Df, less than 0.005, at 1 kHz, 23° C. (73° F.).

In an embodiment, each polymer film 1300.1, 1300.2, 1300.3, of the at least three polymer films 1300 has a thickness equal to or greater than 0.1 mil (2.5 um) and equal to or less than 10 mil (125 um).

In an embodiment, the first outer copper layer 1100, the second outer copper layer 1200, and the at least three polymer films 1300 form a laminate stack 1400, wherein the laminate stack 1400 is adhesively bonded together, or fusion bonded together.

In an embodiment, the at least three polymer films 1300 are an odd number of polymer films 1300.1, 1300.2, 1300.3, and are symmetrically arranged about a central one 1300.2 of the odd number of polymer films 1300.1, 1300.2, 1300.3.

In an embodiment, each polymer film 1300.1, 1300.2, 1300.3, of the at least three polymer films 1300 is a non-polar polymer film.

In an embodiment, each polymer film 1300.1, 1300.2, 1300.3, of the at least three polymer films 1300 is a hydrolysis-resistant polymer film.

In an embodiment, each polymer film 1300.1, 1300.2, 1300.3, of the at least three polymer films 1300 is composed of any one of the following materials: an aromatic polyimide (PI); a polyetheretherketone; a polyetherimide; a polysulfone; a polyether sulfone; a polyphenylene sulfide (PPS); a polyethylene naphthalate (PEN); a polyfluoroalkoxy (PFA); a liquid-crystal polymer (LCP); or a thermoset resins: bismaleimide resin, bismaleimide-triazine resin, cyanate ester resin.

In an embodiment, one polymer film 1300.1, 1300.2, 1300.3, of the at least three polymer films 1300 comprises a ceramic filler 1350.

In an embodiment, the ceramic filler 1350 is preferred to have properties of low Dk, low Df, low electrical conductivity, and high thermal conductivity. Example materials having such preferred properties include, boron nitride (BN), alumina (Al2O3), and silicas (SiO2), for example.

Table-1 below provides a listing of representative material properties for BN, Al2O3, and SiO2.

TABLE 1

| | | | Electrical | | Thermal |
|---|---|---|---|---|---|
| | | | Resistivity Ω · m | | conductivity |
| Material | DK | DF | DC | AC | (W/mK) |
| SiO2 | 3.8-4.2 | 0.0002 | 10\hat{ }15- | 10\hat{ }10- | 1.4-1.6 |
| | | | 10\hat{ }17 Ω · m | 10\hat{ }12 Ω · m | |
| Al2O3 | 8.5-10.7 | 0.0024 | 10\hat{ }15- | 10\hat{ }10- | 20-30 |
| | | | 10\hat{ }17 Ω · m | 10\hat{ }12 Ω · m | |
| BN | 4-6 | 0.00051 | 10\hat{ }15- | 10\hat{ }10- | 20-200 |
| | | | 10\hat{ }17 Ω · m | 10\hat{ }12 Ω · m | |

In an embodiment, one polymer film layer 1300.1, 1300.2, 1300.3, of the multilayer construction can have a non-woven or woven reinforcing layer that comprises organic or inorganic fibers, such as E-glass fiber, NE-glass fiber, aramid paper, mica paper, non-woven LCP fibers, for example.

In an embodiment, the at least three polymer layers 1300 is equal to or greater than three polymer layers, and equal to or less than 1,000 polymer layers, alternatively equal to or less than 250 polymer layers. For a specific final laminate thickness, the number of polymer layers can be maximized depending on the thickness and dielectric breakdown strength of each layer (see FIGS. 2A-2M for example).

While Kirchoff's voltage law provides an appropriate analytical tool for analyzing theoretical voltages and charges on a capacitor construct, such theory does not address the reality of material impurities or defects that can negatively impact the performance of the capacitor construct. But through the teachings disclosed herein, such material impurities or defects can be addressed to enhance the performance of the capacitor construct.

Having multiple polymer layers that are thin offers advantages over a single polymer layer of the same thickness. Multiple layers reduce the chance of pinholes, voids, porosity, or other defects (foreign particles, gels, fillers, or other agglomerates) that may adversely affect the electrical breakdown performance of the dielectric film. The use of multilayering polymer films helps to greatly eliminate the occurrence of defects that may span the total thickness of the dielectric layer, since the likelihood of overlapping defects in each individual layer is extremely small and therefore defects in any one layer can be avoided. The likelihood of electrical failure across the entire thickness of the dielectric is much less.

On theoretical grounds, electrical stress distribution can be rationally modified to increase short-time breakdown strength. Growth of electrical trees in the long-term, leading to breakdown, can be hindered through the interface blocking effects manifested by systematically varying the relative positions of different films, layer thicknesses, layer count, and the nature of the interfaces.

In addition to high breakdown strength, preferred polymer films should possess dimensional stability, low isotropic coefficient of thermal expansion (CTE), high glass transition temperature, high thermal conductivity, hydrolytic stability, low moisture absorption, good thermal-oxidative stability and relatively stable permittivity and loss tangent over a wide temperature range.

Resistance to hydrolysis minimizes the susceptibility of attack by aqueous acids and aqueous bases during the fabrication of printed circuits. High thermal conductivity is also advantageous in that, while operating, heat is continuously generated within the insulator. If the rate of heat generation exceeds the rate of heat dissipation, then thermally induced polymer degradation may occur.

Aromatic polyimides (PI), polyetheretherketone, polyetherimide, polysulfone, polyether sulfone, polyphenylene sulfide (PPS), a polyethylene naphthalate (PEN), and polyfluoroalkoxy (PFA) are examples of potentially useful, hydrolysis-resistant, polymer films. Films containing ceramic fillers may prove to be useful for the dissipation of heat and dimensional stability. Also, the incorporation of nano/micron sized ceramic fillers can improve dimensional stability, modulus, reduce linear coefficient of thermal expansion and minimizing size variation. The in-plane residual stress formed by dissimilar polymer films can be addressed by incorporating a certain amount of ceramic filler, such as 1-10% by weight, alternatively 1-20% by weight, and maximum 30% by weight. Additionally, by providing the multilayered construction as disclosed herein with a non-woven or woven reinforcing layer that comprises organic or inorganic fibers, the overall thermal expansion coefficient of the composite material can be reduced, which helps to enhance the dimensional stability and modulus of the laminate.

Bonding layers mitigate the higher moisture absorption properties of PI, thus reducing the probability of increased dielectric loss and reduced dielectric strength resulting from absorbed moisture.

In an example embodiment, several multilayer composite substrates comprising alternating layers of PI and PFA films were fabricated using a lamination press. Heat and pressure were applied to fuse the film layers together. The choice of films provided a relative permittivity contrast of approximately 1.5 units, 3.5 vs. 2.0, respectively. In two experiments, a layer of 1035-style E-glass fabric with a thin coating of polytetrafluoroethylene (PTFE) and fluorinated ethylene propylene (FEP) was incorporated to serve as reinforcement. Details of example multilayer constructions are shown in the schematic diagrams in FIGS. 2A-2M.

Lamination was performed using a pressure of 350 psi and an ultimate platen temperature of 320° C. Since PFA melts at temperatures in the range of 302 to 310° C., it served as the bonding medium for the layers of PI. PFA bonds well to relatively smooth copper foils, which is another benefit because electrical charges tend to concentrate on the sharp asperities of rough conductor surfaces.

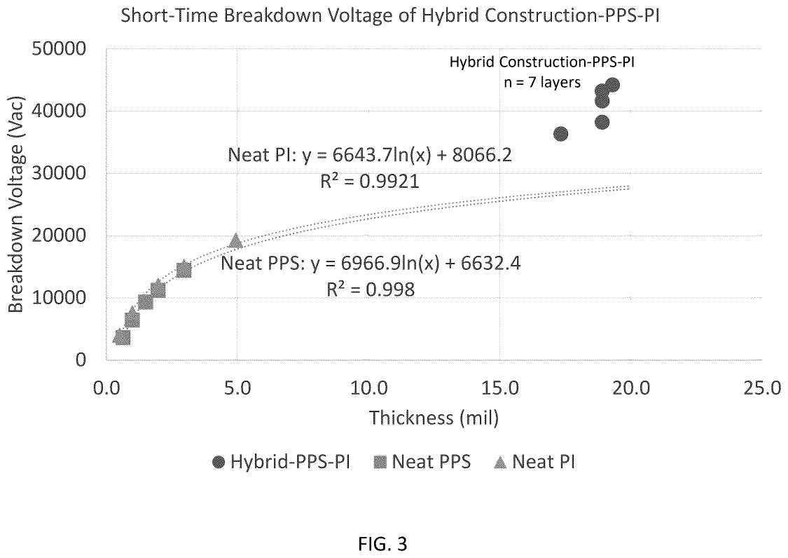

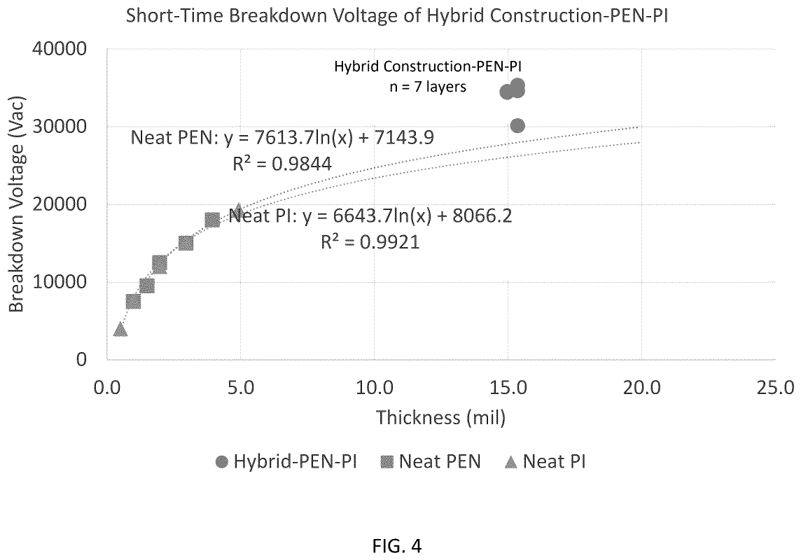

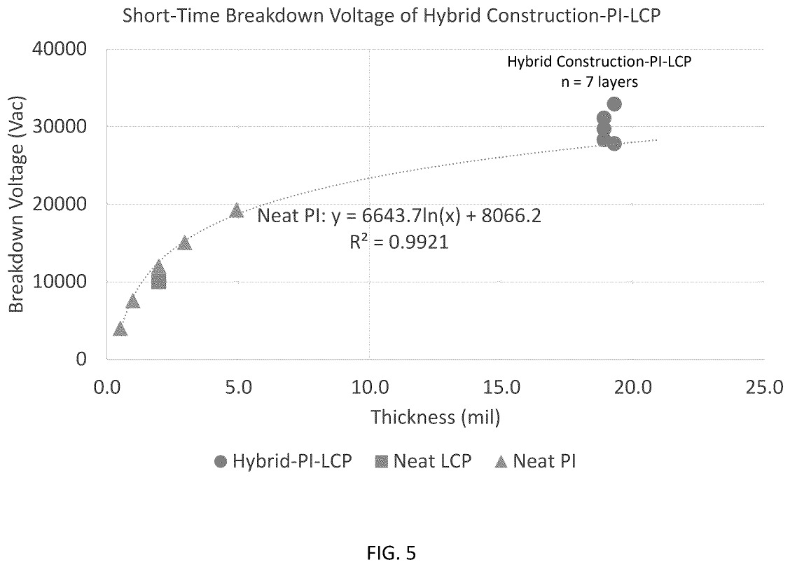

In FIGS. 3-5, the breakdown voltage of three different hybrid constructions as disclosed herein are presented that can achieve improved breakdown voltage as compared with neat PI and neat PFA at the same thickness. As depicted, data sheet data, in combination with empirical data, for certain neat PI and neat PFA materials is plotted and extrapolated out for greater thicknesses and higher breakdown voltages, along with test data of hybrid constructions. As can be seen, each hybrid construction, in accordance with an embodiment disclosed herein, exceeds the extrapolated breakdown voltage of a neat PI or a neat PFA material of the same thickness. Additionally, the improvement of breakdown voltage increases with the increase of PI volume fraction. It is expected that the dielectric strength of PI is higher than that of PFA, and when higher voltages are distributed to the PI layer rather than the PFA layer, the overall structure can thus carry higher breakdown voltages by designing the thickness of each polymer films and using the varying polymer films (A-B-C-D-C-B-A, for example—see FIGS. 2A-2M for a more complete grouping of varying polymer films) within a cladding construction. While FIGS. 2A-2M depict a certain arrangement of varying polymer films, it will be appreciated that other arrangements are possible and contemplated herein. For example, a layering arrangement of materials A-B1-B2-C-B2-B1-A is contemplated, where A, B, and C, are different polymer film materials disclosed herein, and where B1 and B2 are different thicknesses of the B polymer film material (see FIG. 1 for example, where material-A is represented by 1300.1, material-B is represented by 1300.2, and material-C is represented by 1300.3). Any and all such layering arrangements are contemplated and considered to be at least inherently, if not specifically, disclosed herein.

A wider range of materials depicted in FIGS. 2A-2M were included in the assessment. These polymer films possess similar relative permittivity's (PI: 3.4, PPS: 3.0, PEN: 3.2, LCP: 3.3). The thermoset resin system (TRs) comprises Poly(styrene-butadiene-styrene) (SBS), polyphenylene ether (PPE) and cross-linking agent triallyl isocyanurate (TAIC), which exhibited a relative permittivity of 2.4.

The multilayered structures studied validated improved breakdown voltage, which is illustrated in FIGS. 3-5. Several of the laminated structures in FIGS. 2A-2M used different thicknesses of PI and the bonding films (PPS, PEN, and LCP). The bonding force between layers in multilayer structures plays an advantageous role in the breakdown strength. Optimizing the configuration of the interlayer structure improves the layer-to-layer adhesion, thus improving breakdown voltage. Good bonding between layers can reduce defects such as cracks, cavitation, delamination, etc., and thus improve the electrical insulation performance. As a contrast, the surface energy of TRs, differed greatly from the PI and LCP polymer films resulting in poor interlaminar adhesion and no improvement in breakdown voltage.

Short-term breakdown voltage measurements in accordance with ASTM D-149 Method-A are depicted in the graphs in FIGS. 3-5. All multilayer substrates withstood more than 30,000 volts (AC). Additionally, the multilayer constructions exhibited breakdown voltages that exceed the extrapolated values for neat polymer films of comparable thicknesses. As used herein, the term “neat” is a term of art that means a polymer film that consists solely of the identified polymer material.

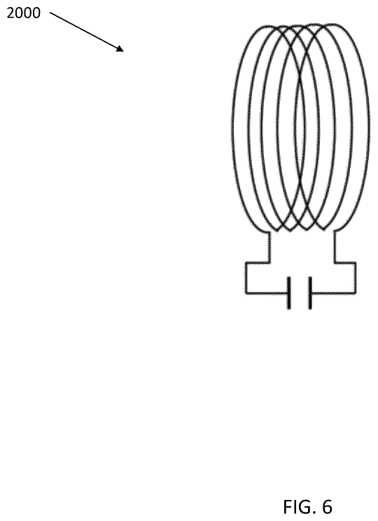

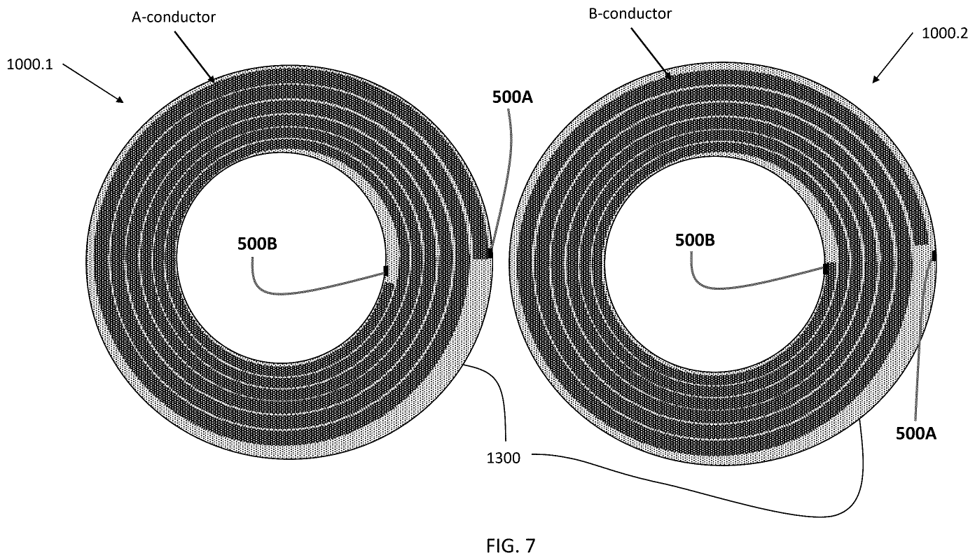

With reference to FIGS. 6 and 7, in combination with FIG. 1, in an embodiment an application for any laminate 1000 disclosed herein and falling within a scope of the appended claims includes an arrangement where the first and second outer copper layers 1100, 1200 are structured and configured to form a segment of a capacitively coupled inductive coil 2000, or a complete capacitively coupled inductive coil 2000. In an embodiment, the inductive coil 2000 is formed by appropriately patterning the first and second outer copper layers 1100, 1200 to form conductors, such as the A-conductor and B-conductor on laminates 1000.1, 1000.2 depicted in FIG. 7 for example, and then layering a plurality of the laminates 1000.1, 1000.2 with the patterned conductors to produce the inductive coil 2000. In an example embodiment of a stack up of a plurality of laminates 1000.1, 1000.2 in a coil 2000, the A and B conductors alternate with each other in an arrangement of stacked A-B-A-B conductor layers or B-A-B-A conductor layers. In another example embodiment, the A-conductors are electrically connected to each other by way of electrical paths 500A, and the B-conductors are electrically connected to each other by way of electrical paths 500B.

While certain combinations of individual features have been described and illustrated herein, it will be appreciated that these certain combinations of features are for illustration purposes only and that any combination of any of such individual features may be employed in accordance with an embodiment, whether or not such combination is explicitly illustrated, and consistent with the disclosure herein. Any and all such combinations of features as disclosed herein are contemplated herein, are considered to be within the understanding of one skilled in the art when considering the application as a whole, and are considered to be within the scope of the invention disclosed herein, as long as they fall within the scope of the invention defined by the appended claims, in a manner that would be understood by one skilled in the art.

While an invention has been described herein with reference to example embodiments, it will be understood by those skilled in the art that various changes may be made and equivalents may be substituted for elements thereof without departing from the scope of the claims. Many modifications may be made to adapt a particular situation or material to the teachings of the invention without departing from the essential scope thereof. Therefore, it is intended that the invention not be limited to the particular embodiment or embodiments disclosed herein as the best or only mode contemplated for carrying out this invention, but that the invention will include all embodiments falling within the scope of the appended claims. In the drawings and the description, there have been disclosed example embodiments and, although specific terms and/or dimensions may have been employed, they are unless otherwise stated used in a generic, exemplary and/or descriptive sense only and not for purposes of limitation, the scope of the claims therefore not being so limited. When an element such as a layer, film, region, substrate, or other described feature is referred to as being “on” or in “engagement with” another element, it can be directly on or engaged with the other element, or intervening elements may also be present. In contrast, when an element is referred to as being “directly on” or “directly engaged with” another element, there are no intervening elements present. The use of the terms first, second, etc. do not denote any order or importance, but rather the terms first, second, etc. are used to distinguish one element from another. The use of the terms a, an, etc. do not denote a limitation of quantity, but rather denote the presence of at least one of the referenced item. The use of the terms “top”, “bottom”, “up”, “down”, “left”, “right”, “front”, “back”, etc., or any reference to orientation, do not denote a limitation of structure, as the structure may be viewed from more than one orientation, but rather denote a relative structural relationship between one or more of the associated features as disclosed herein. The term “comprising” as used herein does not exclude the possible inclusion of one or more additional features. And, any background information provided herein is provided to reveal information believed by the applicant to be of possible relevance to the invention disclosed herein. No admission is necessarily intended, nor should be construed, that any of such background information constitutes prior art against an embodiment of the invention disclosed herein.

In view of all of the foregoing, it will be appreciated that various aspects of an embodiment are disclosed herein, which are in accordance with, but not limited to, at least the following aspects and/or combinations of aspects.

Aspect 1: A laminate, comprising: a first outer copper layer; a second outer copper layer; a multilayer construct comprising at least three polymer films disposed between the first and second outer copper layers; wherein adjacent ones of the at least three polymer layers have dissimilar dielectric constant, Dk, values, dissimilar thicknesses, or preferably both dissimilar Dk values and dissimilar thicknesses; wherein adjacent ones of the first and second outer copper layers, and the at least three polymer layers, are bonded to each other; wherein each polymer film of the at least three polymer films has a voltage breakdown strength equal to or greater than 200 kV/mm, or equal to or greater than 5 kV at a film thickness of 25 micrometers.

Aspect 2: The laminate of Aspect 1, wherein: each polymer film of the at least three polymer films has a volume resistivity larger than 1×10¹⁵ Ω-m.

Aspect 3: The laminate of any one of Aspects 1 to 2, wherein: each polymer film of the at least three polymer films has a similar dielectric constant less than 10, at 1 kHz, 23° C. (73° F.).

Aspect 4: The laminate of any one of Aspects 1 to 3, wherein: each polymer film of the at least three polymer films has a similar dissipation factor less than 0.005, at 1 kHz, 23° C. (73° F.).

Aspect 5: The laminate of any one of Aspects 1 to 4, wherein: each polymer film of the at least three polymer films has a thickness equal to or greater than 0.1 mil (2.5 um) and equal to or less than 10 mil (125 um).

Aspect 6: The laminate of any one of Aspects 1 to 5, wherein: the first outer copper layer, the second outer copper layer, and the at least three polymer films form a laminate stack; wherein the laminate stack is adhesively bonded together, or fusion bonded together.

Aspect 7: The laminate of any one of Aspects 1 to 6, wherein: the at least three polymer films are an odd number of polymer films and are symmetrically arranged about a central one of the odd number of polymer films.

Aspect 8: The laminate of any one of Aspects 1 to 7, wherein: each polymer film of the at least three polymer films is a non-polar polymer film.

Aspect 9: The laminate of any one of Aspects 1 to 7, wherein: each polymer film of the at least three polymer films is a hydrolysis-resistant polymer film.

Aspect 10: The laminate of Aspect 9, wherein: each polymer film of the at least three polymer films is composed of any one of the following materials: an aromatic polyimide (PI); a polyetheretherketone; a polyetherimide; a polysulfone; a polyether sulfone; a polyphenylene sulfide (PPS); a polyethylene naphthalate (PEN); a polyfluoroalkoxy (PFA); a liquid-crystal polymer (LCP); a thermoset resin; bismaleimide resin; bismaleimide-triazine resin; or, cyanate ester resin.

Aspect 11: The laminate of any one of Aspects 1 to 10, wherein: one polymer film of the at least three polymer films comprises a ceramic filler.

Aspect 12: The laminate of Aspect 11, wherein: the ceramic filler has a Dk value equal to or greater than 3 and equal to or less than 11, a DF value equal to or greater than 0.0001 and equal to or less than 0.005, an electrical resistivity value of equal to or greater than 10 ohm-m and equal to or less than 10°ohm-m, and a thermal conductivity value of equal or greater than 1 W/m*K and equal to or less than 200 W/m*K.

Aspect 13: The laminate of Aspect 12, wherein: the ceramic filler comprises any one of or a mixture of the following: SiO2; Al2O3; and, BN.

Aspect 14: The laminate of any one of Aspects 1 to 13, wherein: one layer of the multilayer construct comprises a non-woven or a woven reinforcing layer that comprises organic or inorganic fibers.

Aspect 15: The laminate of Aspect 14, wherein: the one layer comprises E-glass fiber, NE-glass fiber, aramid paper, mica paper, or non-woven LCP fibers.

Aspect 16: The laminate of any one of Aspects 1 to 15, wherein: the at least three polymer films is equal to or greater than three polymer films, and equal to or less than 1,000 polymer films.

Aspect 17: The laminate of Aspect 16, wherein: the at least three polymer films is equal to or less than 250 polymer films.

Aspect 18: The laminate of any one of Aspects 16 to 17, wherein: the at least three polymer films each have a thickness equal to or greater than 0.1 mil and equal to or less than 17 mil.

Aspect 19: The laminate of any one of Aspects 1 to 18, wherein: the at least three polymer films are symmetrically disposed about a central plane that bisects the at least three polymer films in a plane parallel to the at least three polymer films.

Aspect 20: The laminate of any one of Aspects 1 to 19, wherein: the at least three polymer films comprises an odd number of polymer films.

Aspect 21: The laminate of any one of Aspects 1 to 19, wherein: the at least three polymer films comprises an even number of polymer films.

Aspect 22: The laminate of any one of Aspects 1 to 21, wherein: the first and second outer copper layers are structured and configured to form a capacitively coupled inductive coil.

Aspect 23: A capacitively coupled inductive coil, comprising: one or more of the laminate of any one of Aspects 1 to 22; wherein the respective first and second outer copper layers are structured and configured to form the capacitively coupled inductive coil.

What is claimed is:

1. A laminate, comprising:
a first outer copper layer;
a second outer copper layer;
a multilayer construct comprising at least three polymer films disposed between the first and second outer copper layers;
wherein adjacent ones of the at least three polymer layers have dissimilar dielectric constant, Dk, values, dissimilar thicknesses, or preferably both dissimilar Dk values and dissimilar thicknesses;
wherein adjacent ones of the first and second outer copper layers, and the at least three polymer layers, are bonded to each other;
wherein each polymer film of the at least three polymer films has a voltage breakdown strength equal to or greater than 200 kV/mm, or equal to or greater than 5 kV at a film thickness of 25 micrometers.

2. The laminate of claim 1, wherein:
each polymer film of the at least three polymer films has a volume resistivity larger than 1×10¹⁵ Ω-m.

3. The laminate of claim 1, wherein:
each polymer film of the at least three polymer films has a similar dielectric constant less than 10, at 1 kHz, 23° C. (73° F.).

4. The laminate of claim 1, wherein:
each polymer film of the at least three polymer films has a similar dissipation factor less than 0.005, at 1 kHz, 23° C. (73° F.).

5. The laminate of claim 1, wherein:
each polymer film of the at least three polymer films has a thickness equal to or greater than 0.1 mil (2.5 um) and equal to or less than 10 mil (125 um).

6. The laminate of claim 1, wherein:
the first outer copper layer, the second outer copper layer, and the at least three polymer films form a laminate stack;
wherein the laminate stack is adhesively bonded together, or fusion bonded together.

7. The laminate of claim 1, wherein:
the at least three polymer films are an odd number of polymer films and are symmetrically arranged about a central one of the odd number of polymer films.

8. The laminate of claim 1, wherein:
each polymer film of the at least three polymer films is a non-polar polymer film.

9. The laminate of claim 1, wherein:
each polymer film of the at least three polymer films is a hydrolysis-resistant polymer film.

10. The laminate of claim 9, wherein:
each polymer film of the at least three polymer films is composed of any one of the following materials: an aromatic polyimide (PI); a polyetheretherketone; a polyetherimide; a polysulfone; a polyether sulfone; a polyphenylene sulfide (PPS); a polyethylene naphthalate (PEN); a polyfluoroalkoxy (PFA); a liquid-crystal polymer (LCP); a thermoset resin; bismaleimide resin; bismaleimide-triazine resin; or, cyanate ester resin.

11. The laminate of claim 1, wherein:
one polymer film of the at least three polymer films comprises a ceramic filler.

12. The laminate of claim 11, wherein:
the ceramic filler has a Dk value equal to or greater than 3 and equal to or less than 11, a DF value equal to or greater than 0.0001 and equal to or less than 0.005, an electrical resistivity value of equal to or greater than 10 ohm-m and equal to or less than 10°ohm-m, and a thermal conductivity value of equal or greater than 1 W/m*K and equal to or less than 200 W/m*K.

13. The laminate of claim 12, wherein:
the ceramic filler comprises any one of or a mixture of the following; SiO2; Al2O3; and, BN.

14. The laminate of claim 1, wherein:
one layer of the multilayer construct comprises a non-woven or a woven reinforcing layer that comprises organic or inorganic fibers.

15. The laminate of claim 14, wherein:
the one layer comprises E-glass fiber, NE-glass fiber, aramid paper, mica paper, or non-woven LCP fibers.

16. The laminate of claim 1, wherein:
the at least three polymer films is equal to or greater than three polymer films, and equal to or less than 1,000 polymer films.

17. The laminate of claim 16, wherein:
the at least three polymer films is equal to or less than 250 polymer films.

18. The laminate of 16, wherein:
the at least three polymer films each have a thickness equal to or greater than 0.1 mil and equal to or less than 17 mil.

19. The laminate of claim 1, wherein:
the at least three polymer films are symmetrically disposed about a central plane that bisects the at least three polymer films in a plane parallel to the at least three polymer films.

20. The laminate of claim 1, wherein:
the at least three polymer films comprises an odd number of polymer films.

21. The laminate of claim 1, wherein:
the at least three polymer films comprises an even number of polymer films.

22. The laminate of claim 1, wherein:
the first and second outer copper layers are structured and configured to form a capacitively coupled inductive coil.

23. A capacitively coupled inductive coil, comprising:
one or more of the laminate of claim 1,
wherein the respective first and second outer copper layers are structured and configured to form the capacitively coupled inductive coil.
